(19) United States
(12) Patent Application Publication
(10) Pub. No.: US 2006/0029710 A1
(43) Pub. Date: Feb. 9, 2006

(54) Frozen food products and methods for their manufacture

(75) Inventors: Roger E. McPherson, Muscatine, IA (US); Robert L. Olson, Muscatine, IA (US)

Correspondence Address: BANNER & WITCOFF, LTD., TEN SOUTH WACKER DRIVE, SUITE 3000, CHICAGO, IL, 60606, US

(73) Assignee: Grain Processing Corporation, Muscatine, IA (US)

(21) Appl. No.: 11/196,478

(22) Filed: Aug. 4, 2005

Related U.S. Application Data
(60) Provisional application No. 60/599,414, filed on Aug. 6, 2004.

(51) Int. Cl. A23G 9/00

(52) U.S. Cl. 426/565

(57) ABSTRACT

Disclosed is a frozen food product composition that comprises an aqueous ingredient mixture and holocellulose in an amount effective to inhibit ice crystal growth in the frozen food product. Also disclosed is a method of preparing a frozen food product that comprises adding to the ingredient mixture prior to freezing an effective ice crystal growth inhibiting amount of holocellulose. Preferably, the holocellulose is corn hull holocellulose. Holocellulose is effective in stabilizing frozen food products, does not suffer from certain drawbacks associated with other known stabilizers, and can be obtainable inexpensively and in ready supply.

This application claims priority to provisional application Ser. No. 60/599,414 filed Aug. 6, 2004, which is hereby incorporated by reference in its entirety.

### FIELD OF THE INVENTION

The invention is directed to a frozen product including a stabilizer which inhibits ice crystal formation in such product. In preferred embodiments, the invention is directed towards ice cream and other frozen desserts.

### BACKGROUND OF THE INVENTION

Typical ice creams are composed of water, ice, air, sugars or other sweeteners, milk fat, milk protein, and small amounts of functional additive ingredients such as stabilizers and emulsifiers. The physical structure of ice cream is complex. Generally, ice cream comprises at least four discrete phases, which include ice, air, fat, and an unfrozen concentrated aqueous solution. The unfrozen solution includes water, sugar, hydrocolloids, milk proteins, and other soluble substances. The unfrozen solution of such soluble substances is highly concentrated, and usually the freezing point of the solution is sufficiently low such that some water remains unfrozen at a temperature of −16° C., which is a typical ice cream serving temperature. Suspended in the aqueous phase are insoluble solids, which include ice crystals, lactose crystals, and milk solids. The emulsion comprises tiny globules of milk fat and proteins, the proteins being disposed on the surface of the globules thereby stabilizing the globules. Emulsifiers are conventionally added to reduce the stability of the fat globules to allow the globules to partially coalesce. The dispersed phase is a foam which includes air bubbles dispersed in liquid and emulsified and partially coalesced fat. Those skilled in the art will appreciate that there exists a substantial body of literature that relates to ice cream and ice cream manufacturing techniques.

Additives are often used to enhance the homogeneity, texture, and meltdown characteristics of ice cream and, especially, to retain homogeneity under abusive storage and transport conditions. Such functional ingredients often are added to influence the size, distribution, shape, and population of ice crystals, to control ice-crystal growth, and to enhance whipability during aeration during ice cream manufacturing. Ice crystal growth is a particular problem that arises because of temperature cycling of the ice cream, which frequently occurs during transport and shipment. When ice cream is shipped, the ice cream experiences numerous temperature changes. During each temperature fluctuation above freezing, some of the ice crystals may melt and make more water available for migration within the product. With each successive freeze-thaw cycle, water from the melted ice crystals may migrate and re-freeze into larger ice crystals. This phenomenon, also known as heat shock, adversely affects the property of the ice cream.

The prior art has taught many methods for controlling ice crystal size, including using various functional additive ingredients in the ice cream formulation, selecting various processing steps, and controlling temperature during product aging, transport, and storage. Among these, the prior art has taught to add stabilizers to the ice cream. Stabilizers generally are materials that have an affinity to water, and which thereby impede migration of liquid water within the ice cream product. Stabilizers also can promote product uniformity, aid in suspending particles in the base, help with aeration of the ice cream, and make the product clean-cutting during packaging. Subsequent to ice cream production, stabilizers are thought to assist in preventing shrinkage and drying out during storage.

A number of natural occurring products have been employed as ice cream stabilizers. Gelatin is thought to have been the first ice cream stabilizer. More recently, natural gums have been used as stabilizers. Conventional gums include alginates, guar, locust bean, xanthan, and carrageenan gums. For instance, the use of locust bean gum, carrageenan, and xanthan gum in spoonable ice cream is taught in U.S. Pat. No. 4,145,454. Other stabilizers also are known or have been suggested in the art. For instance, the use of partially delignified plant fiber derived from grain bran in frozen pudding pops to control ice crystal formation is taught in U.S. Pat. No. 4,954,360. Microcrystalline cellulose and carboxymethyl cellulose also have been used as stabilizers. High molecular weight starch hydrolyzates (U.S. Pat. No. 5,175,013), microcrystals of sugar alcohols (U.S. Pat. No. 5,324,751), polypeptides (U.S. Pat. No. 5,118,792) and proteins (U.S. Pat. No. 5,620,732) also have been proposed as stabilizers.

Many such gums and other materials are satisfactory, but there remains room for development of new stabilizers in light of certain drawbacks associated with the heretofore discussed materials. For instance, some stabilizers have the undesirable property of promoting whey separation, because they precipitate proteins during pasteurization of the liquid ice cream mix. Moreover, the quality of the foregoing natural stabilizers can vary, and the supply is often unstable due to political factors and climatic conditions. Also, the viscosity of ice creams made with natural gums can become unacceptable to the palate or unworkable in processing. Additionally, ice cream that is improperly stabilized using some of the foregoing materials can exhibit poor meltdown properties. Meltdown is a phenomenon that involves both the melting of the ice crystals and the collapse of the foam structure. Improperly stabilized ice cream can exhibit meltdown characteristics that are perceived as unusual to the consumer, and improper stabilization can even cause the ice cream to appear not to melt at all. In addition, improperly stabilized ice cream may be overly viscous, thus causing manufacturing problems and presenting an overly heavy body.

It has been suggested to use hemicellulose as a stabilizer in frozen food products. Hemicellulose is a soluble product obtainable from a variety of sources, such as soybeans and corn. For instance, U.S. Pat. No. 6,685,977 describes a method for production of frozen desserts that comprises adding water-soluble hemicellulose derived from soybeans during the frozen dessert production process. Hemicellulose derived as a byproduct of the corn wet milling industry has been proposed as a stabilizer for frozen food products (U.S. Pat. Nos. 4,554,360 and 5,112,564). The isolation of corn hull hemicellulose from corn hulls is taught in the technical literature and in U.S. Pat. Nos. 2,801,955, 3,716,526, 2,868,778, and 4,038,481. The aforementioned U.S. Pat. No. 4,554,360 recognizes that ice crystal growth may be impeded by using “Hemicellulose B,” which refers to the portion of hemicellulose that precipitates by ethanol from an acidified hemicellulose mixture that has been isolated from plant material with alkali extraction. Hemicellulose B is believed to be a satisfactory stabilizer in frozen food products. Another document, U.S. Pat. No. 6,551,647, purportedly teaches the use of hemicellulose or pectin in conjunction with chemically modified starch.

For these reasons, hemicellulose is thus generally deemed to be satisfactory for use as a stabilizer in ice cream and other frozen food products. Hemicellulose, however, is not without its own drawbacks. Hemicellulose can affect the taste of the product, and is generally more expensive than desired.

It is therefore desired to provide a stabilizer for frozen food products that does not significantly affect the taste of the final product. In preferred embodiments, the stabilizer should be less expensive than hemicellulose, and should serve as an effective stabilizer for frozen food products without exhibiting the heretofore discussed drawbacks.

### THE INVENTION

It has been found that frozen foods may be stabilized by including in the frozen foods a holocellulose stabilizer in an amount effective to inhibit ice crystal growth in the frozen food. Corn hull holocellulose is deemed particularly suitable as a stabilizer in conjunction with the invention. Holocellulose is a byproduct of the corn wet milling industry, and this product ordinarily is less expensive than hemicellulose. Surprisingly, it has been discovered that holocellulose is not only as effective as hemicellulose in stabilizing frozen food products, but also is less likely to affect adversely the taste of the frozen food products. Frozen food products that may be stabilized by holocellulose include frozen confections such as ice cream, ice milk, frozen custard, frozen yogurt, dessert bars, fruit bars, juice bars, frozen dessert and other such products. In addition, it has been found in connection with preferred embodiments of the invention that holocellulose can serve as an emulsifier in ice cream compositions. Accordingly, additional added emulsifiers often are not needed (or are needed in lesser amounts than would otherwise be required) if holocellulose is employed. Corn hull holocellulose also provides both soluble and insoluble dietary fiber, and imparts a smooth, non-gritty texture. Holocellulose also does not exhibit unsatisfactory whey separation characteristics.

In accordance with one embodiment of the invention, a frozen food product includes a material that is susceptible to ice crystal formation and a holocellulose stabilizer. The stabilizer is present in an amount effective to inhibit ice crystal formation relative to a similar food product prepared in the absence of such stabilizer. Other forms of holocellulose may be employed, but the preferred holocellulose is corn hull holocellulose.

Also encompassed by the invention is a method for preparing a frozen food product. Generally, the method includes providing food product ingredients that include a material that is susceptible to ice crystal formation and a holocellulose stabilizer, and cooling the ingredients so that at least a portion of the water present in such material freezes. Optionally, air is intermixed into the food product (e.g., when the food product is in the form of ice cream).

Other features of preferred embodiments of the invention are discussed hereinbelow.

### DETAILED DESCRIPTION OF THE PREFERRED EMBODIMENTS

In accordance with the invention, holocellulose is employed in the preparation of frozen food products. Generally, the combination of cellulose and hemicellulose within a plant is collectively known as holocellulose, and this material usually accounts for 65 to 75% of plant dry weight. The composition of holocellulose can vary widely depending on the plant material. One skilled in the art would know how to determine the composition of the holocellulose in a plant.

Holocellulose may be obtained from a variety of sources, such as corn hulls, cottonseed hulls, peanut hulls, oat hulls, soybean hulls, paln hulls, coconut hulls, and lees from rice, wheat, beets or potatoes. The preferred holocellulose is corn hull holocellulose, which is obtained by treatment of corn hulls. The remaining discussion focuses on corn hull holocellulose, but it should be understood that holocellulose obtained from other sources may be used as a stabilizer and are within the scope of the instant invention.

The domestic U.S. hybrid corn crop is enormous and stable, and the composition of the corn seeds does not vary significantly. Corn crops provide a reliable, low cost, and consistent source of hulls, bran, and spent germ as byproducts from the production of starch, corn flour, protein and oil. Corn hulls from the corn wet milling industry are a good, inexpensive, source for holocellulose.

Corn hulls may comprise hemicellulose, cellulose, starch, protein, fat, acetic acid, ferulic acid, diferulic acid, coumaric acid, and trace amounts of other materials such as phytosytosterols and minerals. For example, an accepted composition of commercially produced corn hulls or corn bran is as follows:

| | |
|---|---|
| Hemicellulose | 56.38% |
| Cellulose | 18.79% |
| Starch | 8.14% |
| Protein | 7.90% |
| Fat | 1.69% |
| Acetic acid | 3.51% |
| Ferulic acid | 2.67% |
| Diferulic acid | 0.58% |
| Coumaric acid | 0.33% |
| Other (trace) | |

The polymers that comprise holocellulose are made up of simple sugars, such as D-glucose, D-mannose, D-galactose, d-xylose, 1-arabinose, d-glucoronic acid, and other sugars such as L-rhamnose and D-fructose. Cellulose is a glucan polymer of D-glucanopyranose units linked together via β-(1-4)-glucosidic bonds. The average DP (degree of polymerization) for plant cellulose ranges from a low of about 50 to about 600. Cellulose molecules are randomly oriented and have a tendency to form inter-and intra-molecular hydrogen bonds. Most isolated plant cellulose is highly crystalline and may contain as much as 80% crystalline regions. The hemicellulose fraction of plants is composed of a collection of polysaccharide polymers with a typical lower DP than the cellulose in the plant. Hemicellulose contains mostly D-xylopyranose, D-glucopyranose, D-galactopyranose, L-arabinofuranose, D-mannopyranose, and D-glucopyranosyluronic acid, with minor amounts of other sugars. The various forms of hemicellulose and the ratio of hemicellulose to cellulose is not well defined and may vary from plant to plant or from crop to crop within a given plant.

Any suitable holocellulose may be used in conjunction with the invention, so long as it is food-grade. In accordance with preferred embodiments of the invention, the holocellulose is prepared as taught in U.S. Pat. No. 4,104,463 (Antrim et al.) and U.S. Pat. No. 4,239,906 (Antrim et al.). As set forth in U.S. Pat. No. 4,104,463, corn hull holocellulose may be prepared from corn hulls via alkaline hydrolysis using alkali. Sufficient water should be present to solubilize the alkali and non-carbohydrate fraction of the corn hulls, but the moisture should be insufficient to solubilize the majority of the hemicellulose in the plant. The amount of water tolerated depends on a number of factors, such as the particular solvent, the temperature of treatment, and the like, which factors are deemed to be within the purview of one skilled in the art. In accordance with one method, the hydrolysis is performed using an alkaline water-miscible organic solvent system. The extraction solution should comprise from about 60 to about 90% solvent and the remainder water. Water-miscible organic solvents usable in such process include acetone, methanol, ethanol, propanol, isopropanol, s-butyl alcohols and t-butyl alcohols, and mixtures thereof, and similar materials. The corn hulls should be treated with a solution under conditions suitable to extract substantially all non-carbohydrate components of the hulls, with the residue from the extraction comprising the holocellulose fraction of the corn hulls. As will be apparent to one of ordinary skill in the art, the exact amount of hemicellulose that remains in the residue will vary from sample to sample and from extraction to extraction. The extraction preferably is conducted under conditions sufficient to minimize loss of hemicellulose.

In accordance with a second method, alkaline hydrolysis may be carried out under conditions whereby an amount of water not exceeding 65% by weight of the corn hulls, and preferably ranging from 25 to 55% by weight of the corn hulls, is used so that the hemicellulose does not migrate from the corn hull structure. The treated corn hulls then are contacted with a water-miscible solvent to extract the non-carbohydrate fraction, thereby leaving a holocellulose fraction.

The invention is applicable to the production of ice cream and other frozen food products, such as ice milk, frozen custard, “pudding pops,” frozen yogurt, fruit bars, other dessert bars, and so forth using holocellulose. By “frozen food product” is contemplated any product in which at least a portion of the water content of such product is present in the form of ice preferably (but not necessarily) one formed from frozen liquid ingredients. The invention is deemed to find particular applicability to the production of ice cream and related dessert products, such as ice milk, frozen custard, frozen yogurt, dessert bars, fruit bars, juice bars, frozen dessert and so forth.

To be labeled “ice cream,” properly speaking, the product must meet certain criteria, among which are that the product must contain at least 10% milk fat (before the addition of bulky ingredients) and must weigh a minimum of 4.5 pounds per gallon (the actual weight per gallon will be determined in part by the “overrun,” or ratio of air to original liquid volume). Other dessert products that do not conform strictly to the definition of ice cream may be given other names (e.g. “nonfat” ice cream or “dessert bar”). Typical ice cream compositions are described in the following table.

| | | | | % | |
|---|---|---|---|---|---|
| | | % Nonfat | % | Stabilizers & | Approx. Total |
| Product | % Milkfat | Milk Solids | Sweeteners | Emulsifiers | % Solids |
| Nonfat Ice | <0.8 | 12-14 | 18-22 | 1.0 | 35-37 |
| Cream (hard) | | | | | |
| Low-fat Ice | 2-4 | 12-14 | 18-21 | 0.8 | 35-38 |
| Cream (hard) | | | | | |
| Light Ice Cream | 5-6 | 11-12 | 18-20 | 0.5 | 35-38 |
| (hard) | | | | | |
| Reduced-fat Ice | 7-9 | 10-11 | 18-19 | 0.4 | 36-39 |
| Cream (hard) | | | | | |
| Economy Ice | 10-12 | 10-11 | 15 | 0.3 | 35-37 |
| Cream | | | | | |
| Premium Ice | 18-20 | 6-7.5 | 16-17 | 0.0-0.2 | 42-45 |
| Cream | | | | | |
| Super-premium | 20 | 5-6 | 14-17 | 0.25 | 46 |
| Ice Cream | | | | | |
| Frozen Yogurt | 3-6 | 8-13 | 15-17 | 0.5 | 30-33 |
| Low-fat Frozen | 0.5-2 | 8-13 | 15-17 | 0.6 | 29-32 |
| Yogurt | | | | | |
| Nonfat Frozen | <0.5 | 8-14 | 15-17 | 0.6 | 28-31 |
| Yogurt | | | | | |
| Soft-serve | 3-4 | 12-14 | 13-16 | 0.4 | 29-31 |
| Frozen Dessert | | | | | |

Other products must conform to other guidelines. For instance, frozen custard or “French” ice cream must also contain a minimum of 10% milkfat and 1.4% egg yolk solids. Sherbets have a lower milkfat content (1%-2%) and a minimum weight of 6 pounds per gallon. Numerous other frozen food products are presently known. The invention is not limited to any one or several of the foregoing products, but to the contrary is applicable to other forms of frozen food product.

The invention will be described now with particular reference to ice cream, but it should be understood that the invention is not limited thereto.

Any suitable ingredients may be incorporated into the ice cream formulations of the invention. Typical ice cream recipes include a source of milk fat, a source of milk solids (nonfat), a sweetener, a stabilizer, which includes holocellulose and optionally one or more additional stabilizers, optionally an emulsifier, and generally other ingredients such as flavorings and coloring agents, and sometimes inclusions. The source of milkfat is generally cream, but it is contemplated that other sources of milkfat may be used in conjunction with the invention. In some alternative embodiments, low fat content foods contemplated by the invention include food products that contain fat substitutes. Some or all of the milkfat in certain embodiments may be substituted with a fat mimetic composition, as purportedly described in U.S. Pat. No. 5,645,881, or a polyol fatty acid polyester, as purportedly disclosed in WO91/11109. Fats and synthetic fats will sometimes herein be described as “fatty materials.” The milk fat (or alternative fatty material) should be present in any amount effective to form an emulsion. Preferably, the milk fat or other fatty material is present in an amount ranging from 10 to 20% by total weight (this including the total weight of the liquid and solid ingredients less any inclusions and not counting the weight, if any, of the air). In non-ice cream products, a lesser amount of milkfat may be acceptable. The source of remaining milk solids can include materials such as concentrated skim milk, skim milk powder, sweet and condensed whole milk, whey (dried or condensed), buttermilk solids, and optionally one or more whey protein concentrates, such as caseinates, whey powders, whey proteins and caseins, and so forth. Milk solids preferably include lactose. These milk solids may be present in any amount effective to enable the formation of the ice cream structure or other desired structure. Preferably, the nonfat milk solids are present in an amount of from 5 to 15% by total weight.

Any suitable sweetener may be incorporated into the ice cream formulation in accordance with the invention. Generally, the preferred sweeteners include sucrose, glucose, fructose and corn syrups, such as high fructose corn syrup. In some embodiments of the invention, synthetic high potency sweeteners may be used. High potency sweeteners which can be incorporated in the present frozen food products include aspartame, salts and complexes of aspartame, aminoacyl sugars, saccharin, sucralose, alitame, acesulfame K, thaumatin, steveoside and the like. The sweetener may be present in any amount effective to impart a sweet taste to the product. When a natural sweetener such as glucose, fructose, or sucrose is employed, it should be used in an amount ranging from about 10 to 25% by total weight. Artificial sweeteners often are significantly more potent and in such should be used in lesser amounts (based on the active sweetener molecule).

Emulsifiers may include any suitable ingredients. Historically and conventionally, the preferred emulsifier is egg yolk. The emulsifier should be present in an amount effective to enhance the fat structure of the ice cream (or other nonfat structure in alternative embodiments that do not employ milkfat). If egg yolk is not used, other conventional emulsifiers such as mono and di-glycerides or polysorbate 80 may be employed in conjunction with the invention. When used, the emulsifier should be present in an amount ranging from 0.1 to 0.3% (egg yolk) or 0.1 to 0.3% (other conventional emulsifiers). As hereinbefore indicated, it is contemplated that emulsifiers need not be used in conjunction with the preparation of ice cream compositions.

The flavorings employed in conjunction with the invention may be any suitable material, such as chocolate, vanilla, fruit flavors, nut flavors, and so forth. Likewise, the inclusions may be selected from among any suitable ingredients, such as chocolate chips, vanilla chips, peanut butter chips, nuts, fruit pieces, candies, and so forth. The flavorings should be added in an amount effective to impart flavor. When used, the inclusions may be present in any suitable amount (e.g., to impart flavor or ornamental appearance).

In accordance with the invention, holocellulose is employed as a stabilizer in the frozen food product. The stabilizer should be added to an aqueous ingredient mixture, prior to freezing, in an amount effective to inhibit ice crystal growth in the frozen food product as compared to an otherwise similar food product prepared in the absence of the stabilizer. Usually, the stabilizer is added in amounts of from about 0.01 to about 2% total weight of the food product, preferably in amounts of from about 0.05 to about 1.0% by total weight and more preferably in amounts of from about 0.1 to about 0.5% total weight of the frozen food product. Other stabilizers may be included if desired.

The frozen food product may be prepared in any conventional or other suitable manner. When the product is ice cream, conventionally, the ingredients that will form the ice cream (with the exception of ingredients such as nuts, chips and other inclusions) are blended and pasteurized. The pasteurized ingredients are homogenized to reduce the size of fat particles, and allowed to age for a period of time sufficient to hydrate the stabilizers (typically 4-30 hours). The homogenized mixture then is frozen to a soft consistency, and the inclusions or other remaining ingredients that will form including the product (if any) are added. Flavorings, coloring agents, and the like may be added at any suitable time. During this step, air is whipped into the mixture. The overrun preferably ranges from about 3 to 50%, but may be higher in certain embodiments. In a product with 100% overrun, air will compromise 50% by volume of the product. Finally, the mixture of ingredients is packaged and frozen at a very low temperature (−30 to −60° F.) to harden the ice cream. Soft-serve frozen dessert typically does not undergo a final freezing step. The exact processing steps for a particular frozen product formulation will be left to the discretion of those skilled in the art. When the product takes the form of a frozen food product other than ice cream, the product may be prepared in any suitable manner.

It is contemplated in certain embodiments of the invention that selected amounts of ingredients, which include water, a fatty material, a proteinaceous material (such as that derived from milk solids), a sweetener, and a flavoring agent may be selected for blending into a food product which is intended for freezing. The invention in this embodiment can comprise selecting suitable ingredients and an amount of holocellulose stabilizer that is effective to inhibit ice crystal formation in a frozen food product prepared from such ingredients, the stabilizer being in an amount effective to inhibit ice crystal formation relative to an otherwise similar material prepared in the absence of the stabilizer. The materials are then blended and cooled until at least a portion of the water in the mixture freezes. The method can comprise determining a desired range of holocellulose stabilizer, and adding an amount of holocellulose stabilizer that falls within the range. Alternatively, a predetermined range of holocellulose stabilizer for use with such ingredients can be provided, and an amount of holocellulose stabilizer falling within the predetermined range may be added. It is contemplated in these embodiments that the holocellulose stabilizer might be added by a commercial formulator of the various materials.

In other embodiments of the invention, a method for preparing a frozen food product comprises providing a mixture of water, a fatty material, a proteinaceous material, a sweetener, a flavoring agent, and an amount of holocellulose stabilizer effective to inhibit ice crystal formation in the frozen food product relative to an otherwise similar material prepared in the absence of the stabilizer, and cooling the mixture of such ingredients until at least a portion of the water in the mixture freezes. The invention may further or alternatively comprise serving a portion of said frozen food product thus prepared. It is contemplated that these methods might be practiced by a vendor of frozen food products, such as an ice cream parlor, or by a formulator of such products. The ice cream parlor or other vendor may dispense a portion of the frozen food product into a suitable container, such as a dish or cone. No special equipment or methods of dispensing are contemplated, but to the contrary any suitable equipment or methods may be employed.

Holocellulose can be natural or synthetic. Synthetic holocellulose can be made by blending hemicellulose and cellulose. See e.g., EXAMPLE 7 below. The holocellulose described in the following passages and examples is a physical mixture of water soluble hemicellulose and water insoluble cellulose arabinoxylan.

The synthetic holocellulose may also be prepared by blending partially depolymerized hemicellulose with cellulose. The partially depolymerized hemicellulose can be obtained by any suitable method, but preferably is obtained by the partial depolymerization of a soluble hemicellulose precursor. The soluble hemicellulose precursor comprises or is obtained from the hemicellulose-containing soluble phase obtained by hydrolysis of a hemicellulose-containing plant source. In accordance with a highly preferred embodiment of the invention, the partially depolymerized hemicellulose is obtained by the partial depolymerization of a soluble hemicellulose precursor that is substantially completely free of cellulose and other insoluble components from the plant source from which the hemicellulose is obtained, as taught in U.S. Pat. No. 6,063,178. As provided in more detail therein, the hemicellulose precursor most preferably is obtained from a soluble phase extracted from hydrolyzed destarched corn hulls produced by the corn wet milling industry.

In accordance with a preferred embodiment of the invention, hemicellulose is removed from the hemicellulose-containing plant source in a soluble phase. Preferably, at least a majority of the hemicellulose component of the plant source, more preferably substantially all of the hemicellulose portion, is separated from insoluble components of the plant source. For example, when the hemicellulose-containing plant source comprises corn hulls, the soluble phase preferably is extracted from the corn hulls. The hemicellulose is extracted by heating an aqueous alkaline slurry of the corn hulls to a temperature of at least about 130° F. (54.5° C.), more preferably at least about 212° F. (100° C.), for a time sufficient to extract a substantial portion of the hemicellulose and other soluble components from the corn hulls. When the corn hull slurry is heated to boiling at atmospheric pressure, it has been found that the slurry should be heated with agitation for a time of at least about 60 minutes, more preferably at least about 80 minutes, and most preferably at least about 120 minutes, to extract the hemicellulose. This time may be substantially shortened if the corn hull slurry is cooked at higher temperatures under pressure. For example, corn hulls may be cooked at 315° F. (157° C.) at 70 psig for a time of about 5 minutes. Generally, any other reaction conditions as may be found to be suitable may be employed in conjunction with the invention.

Insolubles, for example, cellulose, are then physically removed from the reaction mixture, for example, by centrifugation. The soluble phase will contain hemicellulose and other soluble components. For example, it is believed that the soluble phase will contain protein hydrolyzate, salts of fatty acids, glycerin, and salts of natural acids, such as ferulic acid and coumaric acid. It should be understood that although the foregoing represents the preferred method of obtaining the hemicellulose precursor, any hemicellulose obtained via any method may be depolymerized and used in connection with the invention.

After the hemicellulose precursor is obtained, the soluble hemicellulose and other soluble components of the corn hulls then may be concentrated, or water may be removed substantially completely, such as by evaporation or spray-drying, to provide a solid hemicellulose-containing soluble phase. The hemicellulose in the hemicellulose-containing soluble phase can then be depolymerized in any suitable manner as described hereinbelow, and used in accordance with the present invention. Alternatively, the hemicellulose in the hemicellulose solution may be depolymerized prior to concentration and the resulting product optionally concentrated and used. It is further contemplated that the hemicellulose may be partially depolymerized prior to separation of the hemicellulose in a soluble phase from insoluble portions of a hydrolyzed plant source, although such is not presently contemplated to be preferred.

The hemicellulose can be partially depolymerized by any suitable method known in the art or otherwise as may be found to be suitable. The term “partially depolymerized,” as used herein refers generally to the product obtained when hemicellulose is subjected to a depolymerization reaction under conditions such that a partially depolymerized hemicellulose is obtained. Partial depolymerization of cellulose and hemicellulose are known in the art and can be accomplished, for example, enzymatically or chemically. Enzymatic partial depolymerization is described, for example, in U.S. Pat. Nos. 5,200,215 and 5,362,502. Chemical partial depolymerization is described, for example, in R. L. Whistler and W. M. Curbelt, J. Am. Chem. Soc., 77, 6328 (1955). The product of partial depolymerization of the hemicellulose has not been characterized with certainty, but it is presently believed that partial depolymerization by enzymatic methods occurs via random enzymatic cleavage.

Preferably, the partial depolymerization reaction is carried out enzymatically, i.e., under enzymatic catalysis. In a preferred embodiment, the hemicellulose is partially depolymerized with a xylanase enzyme, such as a xylanase that is active under acidic pH. In such case, the pH of the hemicellulose-rich soluble phase of the alkaline hydrolyzate typically is undesirably high and should be adjusted to a pH at which the depolymerizing enzyme is active. When a xylanase that is active under acidic conditions is used, the xylanase is preferably one which is active in the hemicellulose-containing soluble phase below about pH 7, and is most preferably active in the hemicellulose-containing soluble phase at about pH 4.8. In a particularly preferred embodiment, the enzyme utilized in the enzymatic partial depolymerization reaction is GC-140 xylanase, which is available from Genencor International, Rochester, N.Y.

Enzymatic partial depolymerization of hemicellulose may be regulated by controlling the reaction conditions that affect the progress of the depolymerization reaction, for example, the enzyme dosage, temperature, and reaction time. Monitoring of the depolymerization reaction can be accomplished by any suitable method known in the art. For example, the rate or extent of depolymerization can be measured on the basis of viscosity, which typically decreases as the average molecular weight of hemicellulose product decreases during the partial depolymerization reaction. The viscosity (or the rate of change of viscosity over time) can be measured with a viscometer, for example, the rapid viscometer marketed by Foss Food Tech. Corp., Eden Prairie, Minn. When a rapid viscometer is used to measure viscosity, it is preferably measured at 25° C. after the solution is allowed to equilibrate thermally for about 15 minutes.

Any enzyme dosage (weight of enzyme relative to the overall weight of solution) as may be found to be suitable for depolymerizing the hemicellulose may be used in connection with the invention. For example, in one embodiment xylanase enzyme is used at a dosage ranging from about 0.1 g to about 0.3 g of xylanase per about 5000 g of hemicellulose solution obtained from a plant source. It will be appreciated that the rate and/or the extent of depolymerization achieved at one enzyme dosage can be increased by using a relatively higher enzyme dosage. In this regard, the reaction time required to achieve partial depolymerization is inversely proportional to the enzyme dosage. It will also be appreciated that the enzymatic partial depolymerization reaction can exhibit a “plateau,” during the course of the enzymatic partial depolymerization reaction at which the average molecular weight of the partially depolymerized hemicellulose (as evaluated, for example, by viscosity measurements) does not substantially continue to decrease as the reaction continues. Typically, the plateau is preceded by a relatively rapid initial rate of partial depolymerization. It has been found, for example, that the partial depolymerization of a soluble phase hemicellulose solution having an initial viscosity of 290 cp (measured with a rapid viscometer) exhibited a plateau at a viscosity of about 199 cp when the enzyme dosage was 0.1288 g enzyme per 5000 g of hemicellulose solution (9.4% solids). However, when an enzyme dosage of 0.2542 g enzyme per 5000 g of solution was employed under similar conditions the reaction exhibited a plateau at a solution viscosity of about 153 cp. It will thus be appreciated that a particular enzymatic reaction may reach a plateau at a different average molecular weight depending on the enzyme dosage or on the particular enzyme used. Preferably, the enzymatic partial depolymerization is allowed to proceed until the plateau is reached.

The reaction may proceed at any suitable temperature. For example, when GC-140 xylanase (commercially available from Genencor International, Rochester, N.Y.) is used, the temperature is most preferably about 59° C., and the reaction time is most preferably about 4 hours when the xylanase dosage ranges from about 0.1 g to about 0.3 g of xylanase per about 5000 g of reaction solution. The enzymatic reaction can be terminated by any suitable method known in the art for inactivating an enzyme, for example, by adjusting the pH to a level at which the enzyme is rendered substantially inactive; by raising or lowering the temperature, as may be appropriate, or both. For example, xylanases that are active at acidic pH's can be inactivated by raising the pH to about 7.2 and simultaneously raising the temperature to about 90° C.

Any suitable ratio of hemicellulose to partially depolymerized hemicellulose may be used in conjunction with the invention.

The depolymerization of the hemicellulose may proceed to any suitable extent. Generally, it is desired that the partially depolymerized hemicellulose will still have a film-forming property. It is desired to partially depolymerize the hemicellulose in conjunction with the invention to achieve a lower viscosity than that of an otherwise similar hemicellulose, as evaluated in an aqueous solution at the same solids content and temperature. Hemicellulose derived from corn often have a molecular weight in the range of 220,000 Daltons; it is believed that partial depolymerization of this material to an average molecular weight of 70,000 Daltons will provide a partially depolymerized hemicellulose that is suitable for use in conjunction with the invention. In some embodiments of the invention, the hemicellulose may be partially depolymerized to a greater or lesser extent.

The isolation of corn hull hemicellulose from corn hulls is taught in the technical literature and is taught in the following patents: U.S. Pat. No. 2,801,955, U.S. Pat. No. 3,716,526, U.S. Pat. No. 2,868,778, and in U.S. Pat. No. 4,038,481. The isolation of cellulose arabinoxylan is taught in the technical literature (Cereal Chemistry. 78: 200-204). Additionally, the isolation of cellulose arabinoxylan is taught in EXAMPLE 6 below.

The following Examples illustrates the invention, but are not intended to limit the scope of the invention.

### EXAMPLE 1

Corn hulls from a corn wet milling operation are placed on a screen and sprayed with sufficient water at a temperature of 50° C. to remove fine fiber, most of the starch, and some proteinaceous and lipid material. The corn hulls that are retained on the screen were slurried in water a solids concentration of 10%, and the pH is adjusted with lime to approximately 6.5. Alpha-amylase is added to the slurry to obtain a dosage of about 3 liquefons/g of hull solids. The hulls are filtered, washed, and dried. Into a 250 ml 3-neck flask equipped with a stirrer, heater, and condenser are placed 14.18 grams dried basis corn hulls and 150 ml 63% (v/v) aqueous isopropanol containing 1.5 g sodium hydroxide. The reaction mixture is stirred and heated at reflux for four hours, then cooled and filtered through a sintered glass funnel. The insoluble residue is suspended in 150 ml of 63% (v/v) isopropanol, the pH adjusted to 3.0 using dilute hydrochloric acid and the suspension stirred approximately 1 hour at room temperature. The mixture is filtered through a sintered glass funnel and the extraction process is again repeated using 150 ml 63.3% (v/v) aqueous isopropanol. The residue is then air dried and dried in a vacuum at 105° C. to yield natural holocellulose.

### EXAMPLE 2

Batches of vanilla ice cream containing 12% milkfat were made with corn hull holocellulose (in this instance, the natural holocellulose of Example 1) and with corn hull hemicellulose. Each ingredient was incorporated at a low (0.40%) and high (0.80%) level. Two controls, one with a commercial gelatin-based stabilizer and one with no additional stabilizer, were prepared for comparison.

Ice cream was manufactured in 60 pound batches. Mixes were vat pasteurized (160° F., 30 min.), homogenized (2000 psi 1st Stage, 500 psi 2nd Stage), cooled (40° F.) and aged (24 hrs). Products were flavored (2-fold vanilla), frozen to approximately 70% overrun, and a portion packed in three ½ gallon containers and immediately hardened to 20° F. until analysis. The remaining product was left in the machine, and the maximum obtainable overrun was determined.

Each mix formulation was tested for viscosity, maximum overrun obtained, rate of meltdown after hardening, and homogenization efficiency before and after freezing. In addition, the formulations were evaluated for sensory properties using standard grading procedures after hardening and after storage at abusive temperatures (7-10° F. for upwards of two weeks) to evaluate freeze-thaw stability.

The following comparative and inventive formulations were prepared.

Ice Cream Mix Formulation

| Component | Formula 1 | Formula 2 | Formula 3A | Formula 3B | Formula 4A | Formula 4B |
|---|---|---|---|---|---|---|
| (%) | (comp) | (comp) | (inventive) | (inventive) | (comp) | (comp) |
| Milkfat | 12 | 12 | 12 | 12 | 12 | 12 |
| Milk | 12 | 12 | 12 | 12 | 12 | 12 |
| Solids, not | | | | | | |
| fat | | | | | | |
| Sucrose | 15 | 15 | 15 | 15 | 15 | 15 |
| Stabilizer | None | 0.25% | 0.4% corn | 0.8% corn | 0.4% corn | 0.8% corn |
| | | Gelatin | hull | hull | hull | hull |
| | | 250 | holocellulose | holocellulose | hemicellulose | hemicellulose |
| | | Bloom | | | | |
| | | Type A | | | | |
| Total Solids | 39.00 | 39.25 | 39.40 | 39.80 | 39.40 | 39.80 |

Mix Viscosity: The foregoing formulations were allowed to rest undisturbed for 24 hours in 5 gallon stainless steel cans. Mix viscosities were assessed with a Brookfield viscometer with a #2 spindle. Mix temperatures were approximately 40° F.

The following results were obtained.

| Example | 10 RPM | 20 RPM | 50 RPM | 100 RPM |
|---|---|---|---|---|
| 1 (comp) | 0.1 cp | 0.2 cp | 0.9 cp | 2.6 cp |
| 2 (comp) | 1.6 cp | 2.6 cp | 4.5 cp | 7.5 cp |
| 3A (inv) | 0.5 cp | 0.9 cp | 2.1 cp | 4.6 cp |
| 3B (inv) | 3.5 cp | 5.3 cp | 9.2 cp | 14.9 cp |
| 4A (comp) | 0.7 cp | 1.1 cp | 2.4 cp | 5.2 cp |
| 4B (comp) | 2.3 cp | 3.3 cp | 5.7 cp | 9.6 cp |

All treatment viscosities were within reasonable ranges expected for ice cream mix. There was no separation apparent even though the mixes were left undisturbed for 24 hrs.

Mix Freezing: Each product was frozen in 2½gallon batches. Each batch was flavored with 30 mL 3× Bourbon bean vanilla extract.

The following results were obtained.

| | | Overrun at | Max Overrun |
|---|---|---|---|
| Product | Draw Temp (° F.) | Draw (%) | Achieved (%) |
| 1 (comp) | 20 | 67 | 67 |
| 2 (comp) | 20 | 68 | 68 |
| 3A (inv) | 21 | 68 | 105 |
| 3B (inv) | 21 | 72 | 107 |
| 4A (comp) | 21 | 72 | 104 |
| 4B (comp) | 21 | 74 | 95 |

Desired overrun values (about 70%) were all achieved with all batches. Maximum overrun obtained was the greatest with ice cream containing corn hull holocellulose and corn hull hemicellulose. This is a highly desirable trait for soft serve frozen products such as soft frozen dessert and custards, and typically emulsifiers are required. Thus, in accordance with the present invention, the presence of an effective amount of holocellulose reduces the need for additional emulsifiers.

Finished Product Assessments: Sensory analyses were conducted after approximately one week at −20° F. and again after approximately two weeks of abusive temperature storage (approximately six cycles between 4° F. and −1° F.). The following results were obtained.

| | Flavor | Body & Texture |
|---|---|---|
| Product after one | | |
| week of storage | | |
| 1 (comp) | 10 | 4 |
| 2 (comp) | 10 | 4.5 |
| 3A (inv) | 9 | 4.5 |
| 3B (inv) | 9 | 4 |
| 4A (comp) | 7 | 4 |
| 4B (comp) | 6 | 4 |
| Product after two | | |
| weeks of storage at | | |
| abusive temperature | | |
| 1 (comp) | 10 | 2 |
| 2 (comp) | 10 | 4 |
| 3A (inv) | 9 | 4.5 |
| 3B (inv) | 7 | 5 |
| 4A (comp) | 5 | 4.5 |
| 4B (comp) | 4.5 | 4.5 |

Flavor (1-10; 10 = best)
Body and Texture (1-5; 5 = best)

After storage at abusive temperature, the ice-inhibiting capabilities of corn hull holocellulose and corn hull hemicellulose were distinctly manifest. Both products at each level inhibited the growth of ice crystals at least comparable if not an improvement over the control containing a commercial stabilizer. Products containing corn hull holocellulose and corn hull hemicellulose at the 0.8% level were also much glossier than the other treatments. Surprisingly, however, the corn hull holocellulose was rated better in flavor tests than the hemicellulose.

Meltdown Characteristics: Meltdown characteristics were assessed by placing approximately 50 g samples on a metal screen and assessing drip volume over time at ambient temperature. The following results were obtained.

| Product | First drop | 10 ml | 20 ml | Appearance |
|---|---|---|---|---|
| 1 (comp) | 7 sec | 18 sec | 30 sec | curdy |
| 2 (comp) | 8 sec | 22 sec | | curdy |
| 3A (inv) | 11 sec | 43 sec | 74 sec | curdy |
| 3B (inv) | 8 sec | 22 sec | 31 sec | Not curdy |
| 4A (comp) | 12 sec | 41 sec | 71 sec | curdy |
| 4B (comp) | 7 sec | 19 sec | 35 sec | curdy |

Each sample exhibited typical melt characteristics and melting rates, with one significant anomaly. Both 0.4% level samples exhibited a substantial resistance to melt, and it was anticipated that this effect would be also manifest in the 0.8% samples. Remarkably, the opposite occurred, in that each of the 0.8% level samples readily melted at rates similar to the control samples. Although it is not wished to be bound by any particular theory, it is believed that this phenomenon may relate to the ability of the stabilizer to compete for water previously bound to milk components and hence make the ice cream product susceptible to melt.

### EXAMPLE 3

An ice-milk bar is prepared using skim milk (approximately 50%), whole milk (26%), polydextrose (7.5%), maltodextrin (7.5%), non-fat dry milk 4.5%, cocoa 2%, holocellulose stabilizer (1.5%), polysorbate 80 (1%), and aspartame (700 ppm).

### EXAMPLE 4

A fruit bar is prepared using water, strawberry puree, maltodextrin, sorbitol, holocellulose stabilizer, flavor, polysorbate, 80, and aspartame. All components are present in an effective amount to provide the desired product.

### EXAMPLE 5

A juice bar is prepared using water, orange juice concentrate, maltodextrin, sorbitol, holocellulose, citric acid, flavor, polysorbate 80, and aspartame. All components are present in an effective amount to provide the desired product.

### EXAMPLE 6

Continuous Process for the Preparation of Cellulose Arabinoxylan

Dried corn hulls from a corn wet milling process of US Number 2 grade hybrid yellow dent corn are ground to a particle size suitable for jet cooking. The ground corn hulls, 346 pounds as is basis, are placed into 480 gallons of water to form a slurry. NaOH (50%) is added (800 mL) to the slurry in order to achieve a pH of 6.6 at 70° F.

The resulting slurry is continuously jet-cooked in a continuous jet cooker equipped with a Hydroheater Combining Tube which inflicts high shear into the slurry at the point of contact with the high pressure steam at ˜150 psig. The jet-cooking conditions are: Temperature=220° F. to 225° F., Pressure=˜20 psig, Retention Time=4.5 minutes.

The cooked corn hulls are recovered from the cooked slurry by feeding the cooked slurry across a screen having an effective size to separate liquids and solids at high pressure, such as a DSM Screen. The DSM filtered cooked corn hulls are added to a well-agitated tank of 360 gallons of water at 180° F.

The cooked corn hulls are recovered a second time from the slurry at 180° F. by feeding the slurry at 180° F. across a DSM Screen at high pressure. The DSM filtered cooked corn hulls are added to a well-agitated tank of 360 gallons of water at 180° F.

The cooked corn hulls are recovered a third time from the slurry at 180° F. by feeding the slurry at 180° F. across a DSM Screen at high pressure. The DSM filtered cooked corn hulls are added to a well-agitated tank of 360 gallons of water at 180° F.

Calcium Hydroxide (40 pounds) is added to the well agitated slurry. The resulting slurry is continuously jet-cooked in a continuous jet cooker equipped with a Hydroheater Combining Tube which inflicts high shear into the slurry at the point of contact with high pressure steam at ˜150 psig. The jet-cooking conditions are: Temperature=325° F. to 335° F., Pressure=˜95 psig, Retention Time=27 minutes.

The resultant cooked paste is jet-cooked a second time with high pressure steam at ˜150 psig. The jet-cooling conditions are. Temperature=325° F. to 335° F., Pressure=˜95 psig, Retention Time=30 seconds.

The solubilized, extractable hemicellulose and other soluble materials such as polypeptides, phenoxyacid salts, and acetic acid salts, are removed from the remaining cellulose arabinoxylan by centrifugation with a Sharpies P-660 centrifuge. The cellulose arabinoxylan wet cake (300 pounds) is added to water (100 gallons) at 180° F., the pH of the slurry is adjusted to about 7.0 with hydrochloric acid, and the washed cellulose arabinoxylan recovered by centrifugation with a Sharpies P-660 centrifuge. The washing procedure is repeated twice, and the cellulose arabinoxylan is dried in suitable equipment.

If desired, the first slurry of cellulose arabinoxylan is bleached with hydrogen peroxide before the bleached cellulose arabinoxylan is recovered by centrifugation with a Sharpies P-660 centrifuge. Residual oxidant is neutralized by the addition of sodium metabisulfite to the second slurry before recovery of the remaining cellulose arabinoxylan by centrifugation with a Sharpies P-660 centrifuge.

### EXAMPLE 7

Synthetic Holocellulose

The natural holocellulose stabilizer used in EXAMPLES 2, 3, 4, and 5 was assayed to contain 53 parts by weight hemicellulose with 47 parts by weight cellulose arabinoxylan. A Synthetic Holocellulose is fabricated having the same ratio by combining 53 parts by weight hemicellulose with 47 parts by weight cellulose arabinoxylan. Synthetic Holocellulose is used to replace holocellulose stabilizer in EXAMPLES 2, 3, 4, and 5 to give EXAMPLES 8, 9, 10, and 11, respectively.

### EXAMPLE 8

The holocellulose stabilizer of EXAMPLE 2 is replaced with the Synthetic Holocellulose of EXAMPLE 7.

### EXAMPLE 9

The holocellulose stabilizer of EXAMPLE 3 is replaced with the Synthetic Holocellulose of EXAMPLE 7.

### EXAMPLE 10

The holocellulose stabilizer of EXAMPLE 4 is replaced with the Synthetic Holocellulose of EXAMPLE 7.

### EXAMPLE 11

The holocellulose stabilizer of EXAMPLE 5 is replaced with the Synthetic Holocellulose of EXAMPLE 7.

It is thus seen that holocellulose is an effective stabilizer for frozen food products.

While the invention has been described with respect to specific examples including presently preferred modes of carrying out the invention, those skilled in the art will appreciate that there are numerous variations and permutations of the above described systems and techniques. For instance, the invention has been described primarily in contemplation of the preparation of ice cream, but the invention is deemed equally applicable in the context of other frozen foods. For instance, a frozen dessert product may be prepared by using some but not all of the hereinbefore described ice cream ingredients.

All references cited herein are hereby incorporated by reference in their entireties.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention. No language in the specification should be construed as indicating that any non-claimed element is essential to the practice of the invention.

Preferred embodiments of this invention are described herein, including the best mode known to the inventors for carrying out the invention. Variations of those preferred embodiments may become apparent to those of ordinary skill in the art upon reading the foregoing description. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for preparing a frozen food product comprising:
providing food product ingredients comprising at least one material containing water that is susceptible to ice crystal formation and an effective amount of a holocellulose stabilizer effective to inhibit ice crystal formation; and
cooling the ingredients until at least a portion of the water freezes.

2. A method according to claim 1 wherein the holocellulose stabilizer is a corn hull holocellulose stabilizer.

3. A method according to claim 1 wherein air is intermixed into said food product ingredients prior to or upon cooling.

4. A method according to claim 3, the food product comprising a dairy component.

5. A method according to claim 4, the food product being an ice cream that comprises water, a milkfat component, a milk solids (nonfat) component, a sweetener, and a flavoring agent.

6. A method according to claim 1 wherein at least a portion of the water in the material remains liquid at a temperature of −16° C.

7. A method according to claim 1 wherein the holocellulose stabilizer comprises natural holocellulose.

8. A method according to claim 1 wherein the holocellulose stabilizer comprises synthetic holocellulose.

9. A frozen food product comprising a material that is susceptible to ice crystal formation and a holocellulose stabilizer, the stabilizer being present in an amount effective to inhibit ice crystal formation relative to an otherwise similar food product prepared in the absence of such stabilizer.

10. A product according to claim 9 wherein the holocellulose stabilizer comprises a corn hull holocellulose stabilizer.

11. A product according to claim 9 wherein the frozen food product contains a dairy component.

12. A product according to claim 11 wherein the frozen food product is an ice cream that comprises water, a milkfat component, a milk solids (nonfat) component, a sweetener, and a flavoring agent.

13. A product according to claim 9 wherein the frozen food product is selected from the group consisting of ice milk, frozen custard, frozen yogurt, dessert bars, fruit bars, soft serve frozen dessert, and juice bars.

14. A product according to claim 9 comprising about 0.01 to about 2% holocellulose based on total weight of the food product.

15. A product according to claim 9 comprising about 0.05 to about 1.0% holocellulose based on total weight of the food product.

16. A product according to claim 9 comprising about 0.1 to about 0.5% holocellulose based on total weight of the frozen food product.

17. A product according to claim 9 wherein the holocellulose stabilizer comprises natural holocellulose.

18. A product according to claim 9 wherein the holocellulose stabilizer comprises synthetic holocellulose.

19. A method for preparing a frozen food product, comprising selecting desired amounts of ingredients including water, a fatty material, a proteinaceous material, a sweetener, and a flavoring agent;
selecting for said ingredients an amount of holocellulose stabilizer effective to inhibit ice crystal formation in the frozen food product relative to an otherwise similar material prepared in the absence of such stabilizer;
blending said ingredients and said stabilizer to form a mixture; and
cooling said mixture until at least a portion of said water freezes.

20. A method according to claim 19, including determining a desired range of holocellulose stabilizer for said ingredients, and adding an amount of holocellulose stabilizer falling within said range.

21. A method according to claim 19, including providing a predetermined range of holocellulose stabilizer for use with said ingredients, and adding an amount of holocellulose stabilizer falling within said predetermined range.

22. A method according to claim 19 wherein the holocellulose stabilizer comprises natural holocellulose.

23. A method according to claim 19 wherein the holocellulose stabilizer comprises synthetic holocellulose.

24. A method for preparing a frozen food product, comprising providing a mixture of water, a fatty material, a proteinaceous material, a sweetener, a flavoring agent, and a holocellulose stabilizer, the holocellulose stabilizer being effective to inhibit ice crystal formation in the frozen food product relative to an otherwise similar material prepared in the absence of such stabilizer; and
cooling said mixture until at least a portion of said water freezes.

25. A method according to claim 24 wherein the holocellulose stabilizer comprises natural holocellulose.

26. A method according to claim 24 wherein the holocellulose stabilizer comprises synthetic holocellulose.

27. A method for serving a frozen food product, comprising:
providing a frozen food product, said frozen food product comprising a blend of water, a fatty material, a proteinaceous material, a sweetener, a flavoring agent, and a holocellulose stabilizer present in an amount to inhibit ice crystal formation in the frozen food product relative to an otherwise similar material prepared in the absence of such stabilizer, said mixture being at a temperature sufficient to maintain at least of portion of the water in a frozen state; and
dispensing at least a portion of said frozen food product into a serving container.

28. A method according to claim 27 wherein the holocellulose stabilizer comprises natural holocellulose.

29. A method according to claim 27 wherein the holocellulose stabilizer comprises synthetic holocellulose.
